(19) United States
(12) Patent Application Publication
(10) Pub. No.: US 2025/0303893 A1
(43) Pub. Date: Oct. 2, 2025

(54) INTEGRATED AC ON-BOARD CHARGER

(71) Applicant: Ford Global Technologies, LLC, Dearborn, MI (US)

(72) Inventors: Petros G. TASKAS, Novi, MI (US); Baoming GE, Okemos, MI (US)

(73) Assignee: Ford Global Technologies, LLC, Dearborn, MI (US)

(21) Appl. No.: 18/621,355

(22) Filed: Mar. 29, 2024

(51) Int. Cl. B60L 53/24; B60L 53/22; H02M 1/42; H02M 7/5387

(52) U.S. Cl. CPC B60L 53/24; B60L 53/22; H02M 1/4208; H02M 7/53871; B60L 2210/30

(57) ABSTRACT

A switch is connected between a traction battery and transfer circuitry such that, during a drive mode, the switch is open and power from a traction battery bypasses field effect transistors of the transfer circuitry and a transformer of the transfer circuitry, and flows through an inverter system controller to an electric machine, and during a charge mode, the switch is closed and power from a charge source flows sequentially through windings of the electric machine, the inverter system controller, the transformer, and the switch to the traction battery.

### TECHNICAL FIELD

This disclosure relates to automotive power systems.

### BACKGROUND

Unlike traditional internal combustion engine vehicles, electric vehicles utilize electric motors for propulsion, drawing power from on-board energy storage systems, typically lithium-ion batteries.

Electric vehicles may require charging solutions. Certain on-board chargers convert AC power from a grid to DC power at a specified rate.

### SUMMARY

A vehicle includes a traction battery, a power system having an electric machine including windings, transfer circuitry including a plurality of field effect transistors and a transformer, and an inverter system controller connected between the electric machine and the transfer circuitry, and a switch connected between the traction battery and the transfer circuitry. The power system and the switch are configured such that, during a drive mode, the switch is open and power from the traction battery bypasses the field effect transistors and the transformer, and flows through the inverter system controller to the electric machine, and during a charge mode, the switch is closed and power from a charge source flows sequentially through the windings, the inverter system controller, the transformer, and the switch to the traction battery.

A method includes, responsive to a drive mode, opening a switch connected between a traction battery and transfer circuitry including a plurality of field effect transistors and a transformer such that power from the traction battery bypasses the field effect transistors and the transformer, and flows through an inverter system controller to windings of an electric machine; and responsive to a charge mode, closing the switch such that power from a charge source flows sequentially through the windings, the inverter system controller, the transformer, and the switch to the traction battery.

An automotive power control system includes a controller programmed to, responsive to a charge mode, close a switch connected between a traction battery and transfer circuitry and open a pair of switches of the transfer circuitry such that power from a charge source flows through windings of an electric machine, an inverter system controller, a transformer of the transfer circuitry, and the switch to the traction battery.

### BRIEF DESCRIPTION OF THE DRAWINGS

FIG. 1 is a schematic diagram of an AC on-board charger connected between an AC grid and a traction battery.

FIG. 2 is a schematic diagram of a vehicle and certain power-related components therein.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

An AC on-board charger is usually a separate enclosed system consisting of electrical components different from the traction inverter and motor. These systems can also include a power conversion module, adaptive charging control, thermal management, and a communication interface.

Some power conversion modules implement high-efficiency, multi-stage conversion processes that convert AC power to DC power. They may incorporate semiconductor devices with low on-resistance and high thermal endurance, reducing energy loss during conversion.

Adaptive charging controls may utilize algorithms to monitor the battery's state of charge (SoC), temperature, and capacity, and adjust the charging power according to speed and battery health requirements. These systems may also communicate with a power grid or home energy management system to charge the vehicle during off-peak hours.

Thermal management systems may maintain desired temperatures of the charging components and battery during the charging process via active cooling techniques to dissipate heat.

Communication interfaces may support standard charging protocols and allow for smart grid integration. Some may enable the vehicle to participate in demand response programs, where charging can be scheduled or modulated based on grid load.

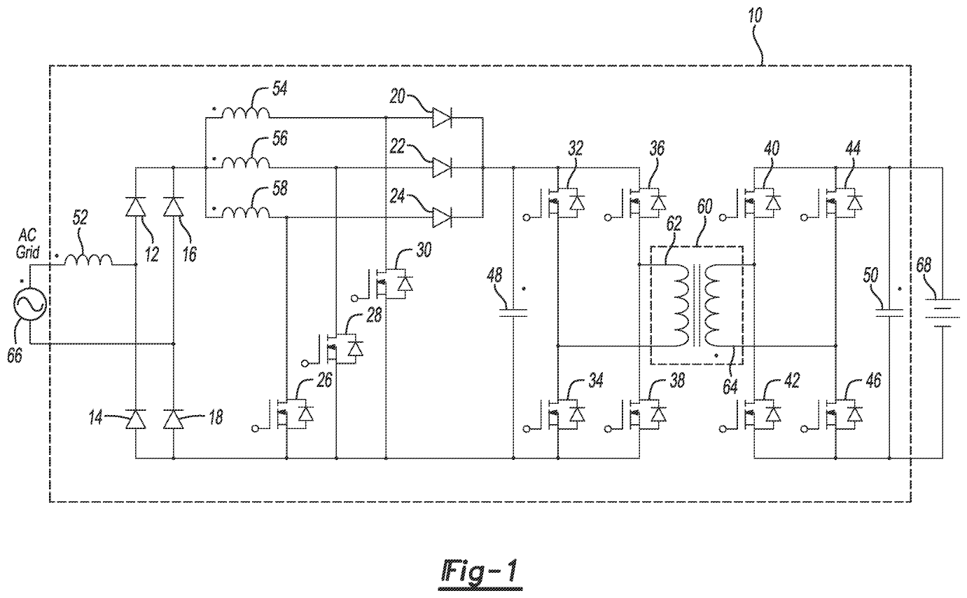

Referring to FIG. 1, a typical AC on-board charger 10 includes diodes 12, 14, 16, 18, 20, 22, 24, active switches 26, 28, 30, 32, 34, 36, 38, 40, 42, 44, 46, capacitors 48, 50, inductors 52, 54, 56, 58, and a high-frequency transformer 60. The diodes 12, 14 are in series and the diodes 16, 18 are in series. The diodes 12, 14 are in parallel with the diodes 16, 18. The diode 20 and inductor 54 are in series, the diode 22 and inductor 56 are in series, and the diode 24 and inductor 58 are in series. The preceding three sets of components are in parallel. A terminal of the active switch 26 is connected between the diode 24 and inductor 58. A terminal of the active switch 28 is connected between the diode 22 and inductor 56. A terminal of the active switch 30 is connected between the diode 20 and inductor 54. The active switches 32, 34 are in series. The active switches 36, 38 are in series. The active switches 40, 42 are in series. The active switches 44, 46 are in series. The active switches 32, 34 and 36, 38 are in parallel. The active switches 40, 42 and 44, 46 are in parallel. The capacitor 48 is in parallel with the active switch is 32, 34. The capacitor 50 is in parallel with the active switches 44, 46. The high-frequency transformer 60 includes a pair of coils 62, 64. Terminals of the coil 62 are connected between the active switches 32, 34 and 36, 38. Terminals of the coil 64 are connected between the active switches 40, 42 and 44, 46.

The AC on-board charger 10 is connected between an AC grid 66 and a traction battery 68. The capacitor 50 is in parallel with the traction battery 68. In total, the AC on-board charger 10 includes seven diodes, eleven active switches, four inductors, two capacitors, and one high-frequency transformer to achieve three-phase interleaved AC on-board charging from the AC grid 66 to traction battery 68. Some AC on-board chargers include more than the number of components shown in FIG. 1. As a result, such chargers can take up significant space and have a certain weight.

As shown, the power factor correction circuit and high-frequency transformer are necessary. The former is to meet power factor requirements and regulatory standards for the AC grid 66, and the latter achieves galvanic isolation.

Here, an AC on-board charger is proposed that uses components from an electric drive system such as an inverter and motor. This allows for use of existing and already present electrical components of the vehicle to reduce the number of additional components, and thus the size and weight, of the AC on-board charger. In one example, an AC on-board charger utilizes an inverter system controller and motor windings. The components include four diodes, eight active switches, one inductor, one power capacitor, one high-frequency transformer, and one relay. Additional contactors are also used but are already part of a high voltage battery system. When compared with the AC on-board charger 10, this can reduce component counts by three diodes, three active switches, three inductors, and one power capacitor while achieving three-phase interleaved AC on-board charging from a power grid to a traction battery. Also, this can reduce the inverter DC bus capacitance because two capacitors are in parallel during vehicle operation.

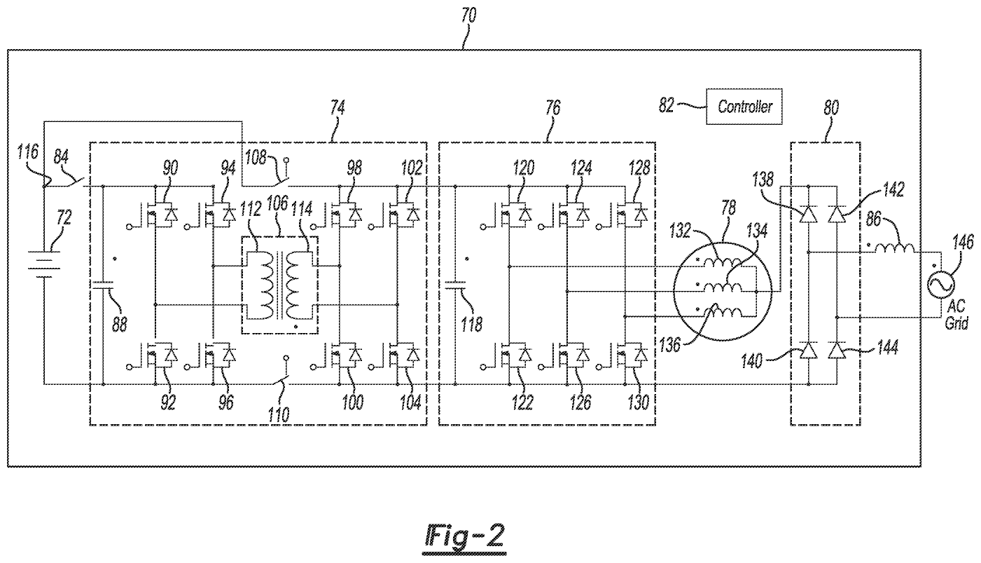

Referring to FIG. 2, a vehicle 70 includes a traction battery 72, transfer circuitry 72, inverter system controller 76, electric machine 78 (e.g., motor), rectifier 80, controller 82, switch 84 (e.g., relay), and inductor 86. The transfer circuit 74 is connected between the traction battery 72 and inverter system controller 76. The inverter system controller 76 is connected between the transfer circuit 74 and electric machine 78. The electric machine 78 is connected between the inverter system controller 76 and rectifier 80. The controller 82 is in communication with/exerts control over the components of FIG. 2. It may implement the algorithms and control strategies contemplated herein.

The transfer circuit 74 includes a capacitor 88, active switches 90, 92, 94, 96, 98, 100, 102, 104 (e.g., field effect transistors with body diodes, such as metal oxide semiconductor field effect transistors), high frequency transformer 106, and switches 108, 110 (e.g., contactors). The active switches 90, 92 are in series. The active switches 94, 96 are in series. The active switches 98, 100 are in series. The active switches 102, 104 are in series. The active switches 90, 92 and 94, 96 are in parallel. The active switches 98, 100 and 102, 104 are in parallel. The capacitor 88 is in parallel with the active switches 90, 92.

The high frequency transformer 106 includes a pair of coils 112, 114. Terminals of the coil 112 are connected between the active switches 90, 92 and 94, 96. Terminals of the coil 114 are connected between the active switches 98, 100 and 102, 104. The switches 108, 110 are on positive and negative rails of the transfer circuit 74, respectively. A terminal of the switch 108 shares a node 116 with a positive terminal of the traction battery 72 and a terminal of the switch 84. The other terminal of the switch 108 is connected with the inverter system controller 76. The switch 110 is connected between the traction battery 72 and inverter system controller 76.

The inverter system controller 76 includes a capacitor 118 and active switches 120, 122, 124, 126, 128, 130 (e.g., field effect transistors incorporating diodes, such as insulated-gate bipolar transistors or metal oxide semiconductor field effect transistors). The active switches 120, 122 are in series. The active switches 124, 126 are in series. The active switches 128, 130 are in series. The capacitor 118 is in parallel with, and connected between, the active switches 102, 104 and 120, 122.

The electric machine 78 includes windings 132, 134, 136. A terminal of the winding 132 is connected between the active switches 120, 122. A terminal of the winding 134 is connected between the active switches 124, 126. A terminal of the winding 136 is connected between the active switches 128, 130.

The rectifier 80 includes diodes 138, 140, 142, 144. The diodes 138, 140 are connected in series. The diodes 142, 144 are connected in series. The diodes 138, 140 and 142, 144 are in parallel. The other terminals of each of the windings 132, 134, 136 are connected together and share a node with cathodes of the diodes 138, 140.

During operation of the vehicle 70, the switches 108, 110 are closed, the switch 84 is open, the active switches 90, 92, 94, 96, 98, 100, 102, 104 are off, and an AC grid 146 (a charge source) is not connected to the vehicle 70. The inverter system controller 76 operates the actives switches 120, 122, 124, 126, 128, 130 via pulse width modulation to convert DC power from the traction battery 72 to AC power to drive the electric machine 78 and propel the vehicle 70. The traction battery 72 thus delivers power to the electric machine 78 and vehicle 70 through the inverter system controller 76 during motoring mode. Generated power is sent back to the traction battery 72 through the electric machine 78 and inverter system controller 76 during generating mode. As suggested above, a size of the capacitor 118 can be reduced relative to that of FIG. 1: The capacitors 88 and 118 are in parallel during operation of the vehicle 70.

During AC on-board charging mode, the inductor 86 is connected between the diodes 138, 140 and AC grid 146 (the AC grid 146 is connected to the input of the rectifier 80), the switches 108, 110 are open, and the switch 84 is closed. The inverter system controller 76, windings 132, 134, 136, and rectifier 80 work together to achieve power factor correction by controlling the inverter system controller 76 to meet the efficiency, power factor requirements, and regulatory standards for the AC power grid 146: The active switches 120, 124, 128 will be off, and the active switches 122, 126, 130 will be pulse width modulated. The active switches 90, 92, 94, 96, 98, 100, 102, 104 are controlled to boost voltage for charging the traction battery 72: They will be pulse width modulated. Here, the high-frequency transformer 106 has two functions of voltage boost and high voltage isolation. If any short circuits occur, the switch 84 can open to manage the situation.

These topologies and strategies can be used, for example, with 400V and 800V electric drive systems. Because the inverter system controller 76 and electric machine 78 are leveraged as described, power factor correction circuitry can be common between 400V and 800V electric drive systems.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials. “Controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a traction battery;
a power system having an electric machine including windings, transfer circuitry including a plurality of field effect transistors and a transformer, and an inverter system controller connected between the electric machine and the transfer circuitry; and
a switch connected between the traction battery and the transfer circuitry, the power system and the switch configured such that, during a drive mode, the switch is open and power from the traction battery bypasses the field effect transistors and the transformer, and flows through the inverter system controller to the electric machine, and during a charge mode, the switch is closed and power from a charge source flows sequentially through the windings, the inverter system controller, the transformer, and the switch to the traction battery.

2. The vehicle of claim 1, wherein the transfer circuitry includes a pair of switches configured to be closed during the drive mode and open during the charge mode.

3. The vehicle of claim 2, wherein one of the pair of switches share a node with a positive terminal of the traction battery and a terminal of the switch.

4. The vehicle of claim 1 further comprising a rectifier connected with the windings such that, during the charge mode, power from the charge source flows first through the rectifier then the windings.

5. The vehicle of claim 4, wherein the rectifier includes a plurality of diodes and wherein the windings share a node with cathodes of some of the diodes.

6. The vehicle of claim 1, wherein the transfer circuitry includes a capacitor configured to be connected in parallel with the traction battery when the switch is closed.

7. The vehicle of claim 1 further comprising a controller programmed to selectively open and close the switch responsive to predefined conditions.

8. The vehicle of claim 1, wherein some of the field effect transistors are connected on one side of the transformer and other of the field effect transistors are connected on another side of the transformer.

9. A method comprising:
responsive to a drive mode, opening a switch connected between a traction battery and transfer circuitry including a plurality of field effect transistors and a transformer such that power from the traction battery bypasses the field effect transistors and the transformer, and flows through an inverter system controller to windings of an electric machine; and
responsive to a charge mode, closing the switch such that power from a charge source flows sequentially through the windings, the inverter system controller, the transformer, and the switch to the traction battery.

10. The method of claim 9 further comprising responsive to the drive mode, closing a pair of switches of the transfer circuitry.

11. The method of claim 10 further comprising responsive to the charge mode, opening the pair of switches.

12. An automotive power control system comprising:
a controller programmed to, responsive to a charge mode, close a switch connected between a traction battery and transfer circuitry and open a pair of switches of the transfer circuitry such that power from a charge source flows through windings of an electric machine, an inverter system controller, a transformer of the transfer circuitry, and the switch to the traction battery.

13. The automotive power control system of claim 12, wherein the controller is further programmed to, responsive to a drive mode, open the switch and close the pair of switches such that power from the traction battery flows through the inverter system controller and to the electric machine while bypassing the switch and the transformer.

14. The automotive power control system of claim 12, wherein one of the pair of switches shares a node with a positive terminal of the traction battery and a terminal of the switch.

15. The automotive power control system of claim 12 further comprising a rectifier connected with the windings such that, during the charge mode, power from the charge source flows first through the rectifier then the windings.

16. The automotive power control system of claim 15, wherein the transfer circuitry includes a capacitor configured to be connected in parallel with the traction battery when the switch is closed.

17. The automotive power control system of claim 16, wherein the transfer circuitry includes a plurality of field effect transistors and wherein some of the field effect transistors are connected on one side of the transformer and other of the field effect transistors are connected on another side of the transformer.
